(19) United States
(12) Patent Application Publication
(10) Pub. No.: US 2002/0163424 A1
(43) Pub. Date: Nov. 7, 2002

(54) Transponder system with a communication station comprising station identification signal generating means

(75) Inventor: Franz Amtmann, Graz (AU)

Correspondence Address: Corporate Patent Counsel, U.S Philips Corporation, 580 White Plains Road, Tarrytown, NY, 10591, US

(73) Assignee: KONINKLIJKE PHILIPS ELECTRONICS N.V.

(21) Appl. No.: 10/139,178

(22) Filed: May 6, 2002

(30) Foreign Application Priority Data
May 4, 2001 (EP) 01 890 130.6

(51) Int. Cl. H04Q 5/22

(52) U.S. Cl. 340/10.1; 340/10.3; 340/5.1

(57) ABSTRACT

A communication station (1) for contactless communication with at least one transponder (2) contains station identification-generating means (7) by means of which a station identification signal (SIDB) can be generated, which can be delivered to the transponder (2) and which can be analyzed in the transponder (2), for which purpose the transponder(2) has station identification signal detection means (45) and station identification signal storage means (46) and station identification signal comparison means (47).

The invention relates to a communication station which is designed for contactless communication with at least one transponder and which has inquiry signal generating means for the generation of at least one inquiry signal and response signal detection means for the detection of at least one response signal and transmission means for the emission of the minimum of one inquiry signal and for the reception of the minimum of one response signal.

The invention further relates to a transponder, which is designed for contactless communication with at least one communication station and which has inquiry signal detection means for the detection of at least one inquiry signal and response signal generating means for the generation of at least one response signal and transmission means for the reception of the minimum of one inquiry signal and for the emission of the minimum of one response signal.

The invention further relates to an integrated circuit for a transponder, which is designed for contactless communication with at least one communication station, the circuit having inquiry signal detection means for the detection of at least one inquiry signal and response signal generating means for the generation of at least one response signal and a connection for the reception of the minimum of one inquiry signal and for the emission of the minimum of one response signal.

Such a communication station and such a transponder and such an integrated circuit are disclosed, for example, by patent document WO 98/32238 A2. In the known designs there is the possibility that once the communication station has performed a communication operation with a transponder, the communication station will generate a quiescent state initiating signal and deliver this to the transponder, with the result that that this transponder is set to quiescent state and consequently cannot participate in any further communication operation initiatable by the communication station, unless the communication station purposely cancels the quiescent state of the transponder in question. This state of affairs has the disadvantage that a transponder, which has been set to its quiescent state by the communication station, is immediately unable, once it has been set to its quiescent state, to perform any communication operation with another communication station, because the transponder is in its quiescent state. In a number of applications this constitutes an unwanted restriction, which is disadvantageous.

It is an object of the invention to overcome the aforementioned restriction and to provide an improved communication station and an improved transponder and an improved integrated circuit for a transponder.

In order to achieve this object in a communication station according to the invention, features according to the invention are provided, so that a communication station according to the invention can be characterized as follows:

Communication station, which is designed for contactless communication with at least one transponder and which has inquiry signal generating means for the generation of at least one inquiry signal for at least one transponder, and which has response signal detection means for the detection of at least one response signal transmitted to the communication station by a transponder, and which has transmission means for the delivery of the minimum of one inquiry signal to the minimum of one transponder and for the reception of the minimum of one response signal transmitted to the communication station by a transponder, station identification signal generating means additionally being provided, by means of which at least one station identification signal can be generated, which can be delivered to at least one transponder by the transmission means, and by means of which the identity of the communication station can be communicated to at least one transponder.

In order to achieve the aforementioned object features according to the invention are provided in a transponder according to the invention, so that a transponder according to the invention may be characterized as follows:

Transponder which is designed for contactless communication with at least one communication station and which has inquiry signal detection means for the detection of at least one inquiry signal transmitted to the transponder by a communication station and which has response signal generating means for the generation of at least one response signal to be transmitted to a communication station and which has transmission means for the reception of the minimum of one inquiry signal and for the delivery of the minimum of one response signal to a communication station, station identification signal detection means being additionally provided for the detection of a station identification signal transmitted to the transponder by a communication station and station identification signal storage means being provided for the storage of a station identification signal transmitted to the transponder by a communication station and station identification signal comparison means being provided, which interact with the station identification signal detection means and with the station identification signal storage means and by means of which a station identification signal stored in the station identification signal storage means can be compared with a station identification signal detected by the station identification signal detection means.

In order to achieve the aforementioned object, features according to the invention are provided in an integrated circuit according to the invention, so that an integrated circuit according to the invention may be characterized as follows:

Integrated circuit for a transponder, which is designed for contactless communication with at least one communication station, which circuit has inquiry signal detection means for the detection of at least one inquiry signal transmitted to the circuit by a communication station and which circuit has response signal generating means for the generation of at least one response signal to be transmitted to a communication station and which circuit has a connection for the reception of the minimum of one inquiry signal and for the delivery of the minimum of one response signal to a communication station, station identification signal detection means being additionally provided for the detection of a station identification signal transmitted to the circuit by a communication station and station identification signal storage means being provided for the storage of a station identification signal transmitted to the circuit by a communication station and station identification signal comparison means being provided, which interact with the station identification signal detection means and with the station identification signal storage means and by means of which a station identification signal stored in the station identification signal storage means can be compared with a station identification signal detected by the station identification signal detection means.

Through the provision of the features according to the invention it is ensured by simple design means and at very little cost that a communication station according to the invention can, where necessary, communicate the station identification signal to any transponder that is in communication with the communication station, so that each transponder in communication with the communication station has the facility firstly for performing a check as to whether the transponder in question has already been in communication with the communication station, and secondly, where such a communication has already existed, of preventing further communication with the communication station. The provision of the features according to the invention furthermore means that a transponder can activate or maintain or modify or circumvent or cancel an operating state according to whether a station identification signal from a specific communication station is detected or not. For example, in the case of a communication between a communication station according to the invention and a transponder according to the invention, it is possible, after reading out specific user information from a memory of the transponders and transmitting this specific user information to the communication station, to set the transponder into a quiescent state, in which it is ensured that further reading out of this specific user information from the transponder memory by means of the same communication station is prohibited, but that subsequent reading out of this specific user information from the transponder memory is permitted using another communication station.

In a communication station according to the invention it has proved advantageous if the station identification signal generating means are designed for the generation of at least two different station identification signals. It is thereby ensured, by simple means, that after reading out user information from a transponder memory and subsequently setting the transponder into a quiescent state, the transponder set to its quiescent state can again be read out using the same communication station, in that in the subsequent read-out operation the communication station delivers a modified station identification signal to the relevant transponder at the same time as a read-out command delivered as inquiry signal.

The aforementioned aspects and further aspects of the invention will be apparent from the example of an embodiment described below and are explained with reference to this example of an embodiment.

The invention will be further described with reference to examples of embodiment shown in the drawings to which, however, the invention is not restricted.

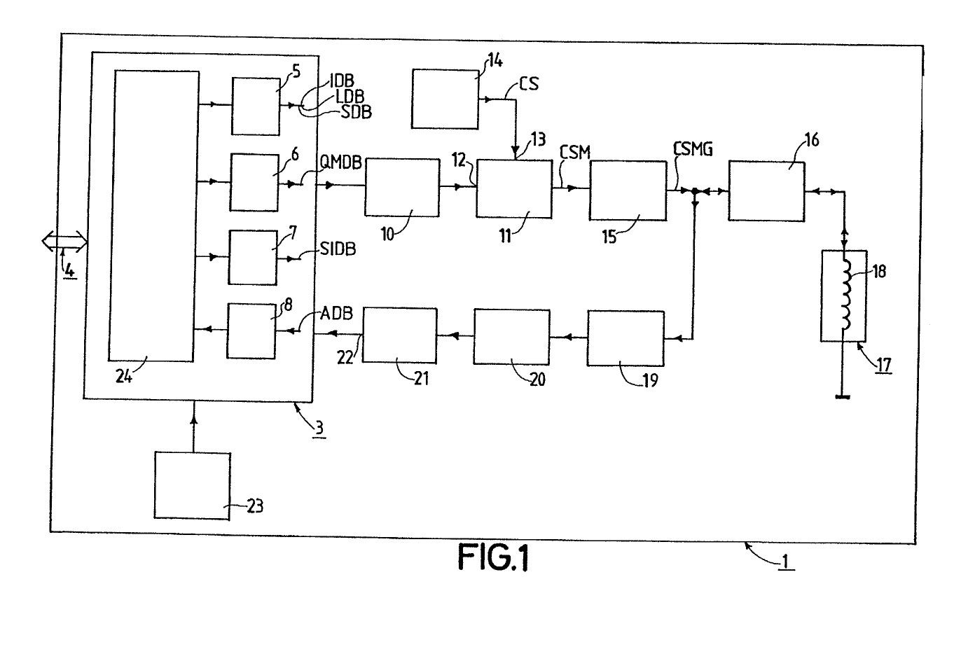

FIG. 1, in very diagrammatic form, shows a block diagram of what is in this context an essential part of a communication station according to an example of an embodiment of the invention.

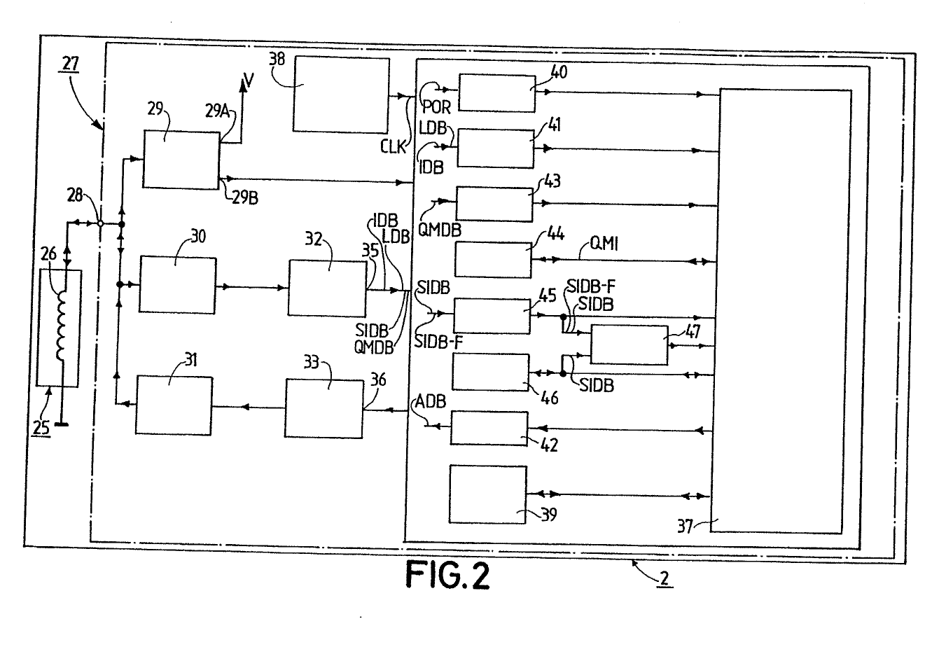

FIG. 2 in very diagrammatic form, shows a block diagram of what is in this context an essential part of a transponder and an integrated circuit for this transponder according to an example of an embodiment of the invention.

FIG. 1 represents a communication station 1, and more especially the circuit design thereof. The communication station 1 is designed for contactless communication with at least one transponder 2, the transponder 2 being represented in FIG. 2. The circuit design of the transponder 2 is explored in more detail below.

The communication station 1 contains a logic circuit 3, which in this case takes the form of a microcomputer 3. However, the logic circuit 3 may also take the form of a hardwired logic circuit. The microcomputer 3 can be connected to a central computer, not shown, by means of a bus connection 4.

Inquiry signal generating means 5 and quiescent state initiating signal generating means 6 and station identification signal generating means 7 and response signal detection means 8 are provided by the microcomputer 3. The inquiry signal generating means 5 are designed for the generation of inquiry signals, the inquiry signals each being formed by an inquiry data block IDB. An inquiry data block IDB can also be formed by an inventory data block or by a read data block LDB or by a write data block SDB or by another data block. The quiescent state initiating signal generating means 6 are designed for the generation of a quiescent state initiating signal, the quiescent state initiating signal being formed by a quiescent state initiating data block QMDB. The station identification signal generating means 7 are designed for the generation of a station identification signal. The station identification signal is here formed by a station identification data block SIDB. The response signal detection means 8 are designed for the detection of a response signal transmitted to the communication station 1 by the transponder 2, the response signal being formed by a response data block ADB.

The communication station 1 furthermore contains a coding stage 10 connected to the microcomputer 3, by means of which coding stage the IDB or QMDB or SIDB data blocks fed to it can be coded, the coding in this case being performed by a so-called Manchester-coding. Another form of coding can also be provided, such as a “no-return-to-zero” (NRZ) coding or a so-called FSK coding. Connected to the coding 10 on the output side is a modulator 11, to a first input 12 of which the coded data blocks can be fed and to a second input 13 of which an unmodulated carrier signal CS can be fed, it being possible to generate the carrier signal CS by means of a carrier signal generator 14 of the communication station 1. The modulator 11 is in this case used for amplitude modulation of the unmodulated carrier signal CS as a function of the coded data blocks that are fed to the first input 12. A frequency modulation or a phase modulation may also be performed instead of an amplitude modulation, for which purpose a suitably designed modulator 11 is then provided. The modulator 11 delivers a carrier signal CSM, modulated according to the coded data blocks, to an amplifier stage 15. Adaptation means 16, by way of which an amplified modulated carrier signal CSMG can be relayed to transmission means 17 of the communication station 1, are connected to the amplifier stage 15. The transmission means 17 contain a transmission coil 18, which is provided and designed for contactless communication. The contactless communication here in this case is purely inductive, that is to say by transformer. The contactless communication may, however, also be performed by capacitive or electromagnetic means, an electromagnetic antenna such as a dipole or a monopole then being provided in place of a transmission coil 18. The transmission means 17 are provided in the communication station 1 both for the emission of inquiry signals, that is of the inquiry data blocks IDB, in their coded and modulated form and also for the reception of a response signal, that is to say a response-data block ADB. Such a response signal, that is a response data block ADB, is in this case transmitted to the communication station 1 through a load modulation of the unmodulated carrier signal CS, as has long been known in the art.

The modulated and coded response signal, that is the modulated response data block ADB produced by load modulation in the communication station 1 is fed by way of the adaptation means 16 to a filter stage 19 of the communication station 1. The filter stage 19 filters out interference signals and delivers the interference-suppressed load-modulated response signal to a demodulator 20 of the communication station 1. The demodulator 20 performs a demodulation of the load-modulated response signal and subsequently emits a demodulated but still coded response signal. For decoding the demodulated but still coded response signal, the communication station 1 has a decoding stage 21, which is connected to the output side of the demodulator 20 and which delivers the decoded response signal, that is to say the decoded response data block ADB at its output 22. The response data block ADB is fed to the response signal detection means 8 of the microcomputer 3 for detection of the response signal, that is to say of the response data block ADB.

It remains to be mentioned, with regard to the communication station 1, that the communication station 1 contains a clock signal generator 23, by means of which a clock signal CLK can be generated, which clock signal CLK can be fed to the microcomputer 3. It must also be mentioned that the microcomputer 3 contains sequence control means 24, by means of which the inquiry signal generating means 5 and the quiescent state initiating signal generating means and the station identification signal generating means 7 together with the response signal detection means 8 can be controlled. The sequence control means 24 permit a combined generation and delivery of a station identification signal SIDB and the quiescent state initiating signal QMDB. The sequence control means 24 furthermore permit a combined generation and delivery of a station identification signal SIDB and an inquiry signal IDB.

The electrical construction of the transponder 2 according to FIG. 2 is described in more detail below.

The transponder 2, like the communication station 1, is designed for contactless communication. The transponder 2 is in this case designed for contactless communication with at least one communication station 1. For contactless communication, the transponder 2 has transmission means 25, which in this instance contain a transmission coil 26. The transmission coil 26 can be coupled to the transmission coil 18 of the communication station 1 inductively, that is to say by a transformer. Instead of a transformer coupling, an electromagnetic coupling can also be provided, as already mentioned above in connection with the communication station 1.

The transponder 2 furthermore contains an integrated circuit 27, which has a connection 28. The transmission coil 26 of the transmission means 25 is directly connected to the connection 28.

The integrated circuit 27 contains voltage supply means 29 and a demodulator 30 and a modulator 31. Here the voltage supply means 29 and the demodulator 30 and the modulator 31 are each connected to the connection 28 of the integrated circuit 27. The voltage supply means 29 are designed to generate a supply voltage V using the signal occurring on the connection 28 of the integrated circuit 27 at any one time. This signal occurring on the connection 28 may be the amplified modulated carrier signal CSMG, but also the unmodulated carrier signal CS. The supply voltage V that can be generated by means of voltage supply means 29 is delivered at a first output 29A of the voltage supply means 29 and fed to all components of the transponder 2 or of the integrated circuit 27 of the transponder 2 that require this supply voltage V. The voltage supply means 29 furthermore have a second output 29B, to which a so-called “power-on-reset” POR signal is delivered when a supply voltage V with a sufficiently high predetermined voltage level is delivered to the first output 29A by the voltage supply means 29, which is the case when the transponder 2 has entered into sufficiently good communication with the communication station 1.

The demodulator 30 is in this case designed as amplitude demodulator, in order to be able to demodulate the signals modulated by the modulator 11 of the communication station 1. The modulator 31 is in this case designed as a so-called load modulator, by means of which the unmodulated carrier signal CS, which can be generated in the communication station 1 by the carrier signal generator 14, can be subjected to a load modulation.

The integrated circuit 27 furthermore contains a decoding stage 32, which is connected to the output side of the demodulator 30. The integrated circuit 27 furthermore contains a coding stage 33, which is connected to the input side of the modulator 31. The decoding stage 32 enables the coding performed by means of the coding stage 10 of the communication station 1 to be reversed. The coding stage 33 undertakes coding of the signals fed to it, the signals taking the form of digital signals, that is to say data blocks. In this case, too, a so-called Manchester coding can be performed, which is then reversed in the decoding stage 21 of the communication station 1.

The transponder 2 or the integrated circuit 27 of the transponder 2 furthermore contains a logic circuit 34, which in the present case takes the form of a microcomputer 34. The logic circuit 34 may also take the form of a hard-wired circuit, however. The output 31 of the voltage supply means 29 and the output 35 of decoding stage 32 and the input 36 of the coding stage 33 are connected to the microcomputer 34.

The microcomputer 34 contains sequence control means 37, by means of which the time sequence required in the microcomputer 34 can be controlled, as has long been known in the art. The microcomputer 34 furthermore contains a clock signal generator 38, by means of which a clock signal CLK can be generated, which can be fed to the sequence control means 37 for timing of the latter. Instead of the clock signal generator 38, the integrated circuit 27 may also contain clock signal regeneration means, which are connected to the connection 28 and which are capable of regenerating a clock signal for the sequence control means 37 from the signals occurring on the connection 28.

The microcomputer 34 furthermore contains storage means 39, which are intended for the storage of user data. In addition to the user data, the storage means 39 are also capable of storing other data and information, which have been transmitted to the transponder 2, for example, by means of the communication station 1 or have been stored in the storage means 39 during manufacture of the transponder 2.

The microcomputer 34 furthermore contains “power-on-reset” signal detection means 40, by means of which the occurrence of a “power-on-reset” signal can be detected. The microcomputer 34 furthermore contains inquiry signal detection means 41, by means of which all inquiry signals, that is to say all inquiry data blocks IDB can be detected. The microcomputer 34 furthermore contains response signal generating means 42, by means of which a response signal of the transponder 2, that is to say a response data block ADB, can be generated.

The microcomputer 34 furthermore contains quiescent state initiating signal detection means 43, by means of which a quiescent state initiating signal, that is to say a quiescent state initiating data block QMDB, transmitted to the transponder 2 by the communication station 1, can be detected. When a quiescent state initiating data block QMDB is detected by means of the quiescent state initiating signal detection means 43, this causes quiescent state information QMI to be stored in quiescent state information storage means 44 of the microcomputer 34.

The microcomputer 34 furthermore contains station identification signal detection means 45, by means of which a station identification signal can be detected, that is to say by means of which it is possible to detect whether a station identification data block SIDB has been received by the transponder 2.

The microcomputer 34 furthermore contains station identification signal storage means 46, which are intended for the storage of a station identification signal SIDB transmitted to the transponder 2 by the communication station 1. When a station identification data block SIDB is detected by the station identification signal detection means 45, this causes the station identification data block SIDB to be stored in the station identification signal storage means 46.

The microcomputer 34 furthermore also contains station identification signal comparison means 47. The station identification signal comparison means 47 interact with the station identification signal detection means 45 and with the station identification signal storage means 46. The station identification signal comparison means 47 enable a station identification signal SIDB stored in the station identification signal storage means 46 to be compared with a station identification signal SIDB detected by the station identification signal detection means 45.

It remains to be mentioned in this instance that, by means of the quiescent state information storage means 44, the transponder 2 or the integrated circuit 27 of the transponder 2 can be fixed in an operating state determined by the stored operating state information. This means, in other words, that should quiescent state information QMI be stored in the quiescent state information storage means 44, the transponder 2 or its integrated circuit 27 can be fixed in a quiescent state. The station identification signal comparison means 47 are here designed to control the fixing of the quiescent states fixed by the quiescent state information storage means 44 according to the results of a comparison that can be obtained by the station identification signal comparison means 47. This control of the fixing of the quiescent states is explored in more detail below.

There follows a more detailed description of a possible operating instance involving the communication station 1 according to FIG. 1 and the transponder 2 according to FIG. 2 and a further communication station, not shown. Let it be assumed that the transponder 2 enters the communication area of the communication station 1. Where this is the case, the voltage supply means 29 of the transponder 2 start to generate the necessary supply voltage V, which results in the occurrence of a “power-on-reset” signal POR on the second output 29B of the voltage supply means 29, the signal being fed to the “power-on-reset” signal detection means 40 of the microcomputer 34. On detection of the “power-on-reset” signal, the “power-on-reset” signal detection means 40 emit control information, which results in all components of the microcomputer 34 being set to a defined output state.

A so-called anti-collision procedure, often also referred to as an inventory procedure, is subsequently performed between the communication station 1 and the transponder 2-which is located not only in the communication area of the communication station 1, but also together with a number of further transponders. This procedure is initiated by a signal combination generated in the communication station 1, which comprises an inventory data block and the station identification data block SIDB. In this anti-collision procedure or inventory procedure, each transponder 2 present in the communication area of the communication station 1 is detected and consequently logged in the communication station 1.

After logging, the communication station 1 performs a read operation with each transponder 2 logged. In order to be able to perform this read operation, the communication station 1 emits a signal combination, which comprises an inquiry signal, that is a read data block LDB, and a station identification signal, that is a station identification data block SIDB, in a combination in which the read data block LDB occurs first followed by the station identification data block SIDB. User data stored in the storage means 39 of the transponder 2 are thereupon transmitted from the transponder 2 to the communication station 1, these user data forming a part of the response signal of the transponder 2 and the response signal being generated by the response signal generating means 42 of the microcomputer 34. It should be mentioned that an inventory operation and a read operation can be activated jointly by means of an other control command and that consequently a read operation can also be performed together with an inventory operation, which is advantageous with a view to minimizing the duration of the communications.

On completion of the transmission of user data from the transponder 2 to the communication station 1, the communication station 1 delivers a further signal combination to the transponder 2, the signal combination comprising the quiescent state initiating signal QMDB and the station identification signal SIDB. As soon as this signal combination is received by the transponder 2 or the integrated circuit 27, this results firstly in the quiescent state initiating signal QMDB being detected by the quiescent state initiating signal detection means 43, which results in the quiescent state information QMI being stored in the quiescent state information storage means 44, and secondly in the station identification signal SIDB being detected by the station identification signal detection means 45, which results in the station identification signal SIDB being stored by the station identification signal storage means 46. This in turn causes the station identification signal comparison means 47 to note that the same station identification signal SIDB is present both in the station identification signal detection means 45 an in the station identification signal storage means 46, which in turn has the result that the quiescent state information QMI remains stored in the quiescent state information storage means 44, as a result of which the transponder 2 and consequently the integrated circuit 27 are fixed in the quiescent state determined by the quiescent state information QMI. This means, in other words, that the station identification signal comparison means 47 are designed to activate the fixing of the quiescent state fixed by means of the quiescent state information storage means 44 according to the result of comparison obtained by means of the station signal identification comparison means 47—namely the parity of the station identification signals SIDB. Instead of the aforementioned signal combination comprising the quiescent state initiating signal QMDB and the station identification signal SIDB, fixing of the quiescent state in the transponder 2 can also be initiated merely by generating the quiescent state initiating signal QMDB in the communication station 1 and transmitting this to the transponder 2, because the station identification signal SIDB has anyway already previously been transmitted to the transponder 2 together with the inventory data block and also the read data block LDB. Instead of a such a separate quiescent state initiating signal QMDB, it is also possible to generate a combined control command in the communication station 1, by means of which an inventory operation and a read operation and a fixing operation for activation of the fixing of the quiescent state in the transponder 2 can be initiated.

If now, for any reason, the communication station 1, for example, again transmits a signal combination to the transponder 2 comprising the read data block LDB and the station identification data block SIDB, this will result in the station identification data block SIDB being again detected by the station identification signal detection means 45, which will cause the station identification signal comparison means 47 to note a parity with the station identification data block SIDB stored in the station identification signal storage means 46, which in this instance will mean that although the newly transmitted read data block LDB is detected by the inquiry signal detection means 41, it cannot give rise to the initiation of a new read operation, because this is prevented by the sequence control means 37.

If, on the other hand, the transponder 2 enters into communication with the further communication station not shown, this will have a different effect if the assumption described below is valid. Let it be assumed that the further communication station delivers a combined signal to the transponder 2, the combined signal comprising a read data block LDB and a different station identification data block SIDB-F. That is to say that the further communication station 1 delivers to the transponder 2 a different station identification data block, namely the station identification data block SIDB-F, from that delivered by the communication station according to FIG. 1, which has delivered the station identification data block SIDB to the transponder 2. If the aforementioned combined signal, which comprises the read data block LDB and the station identification data block SIDB-F, is received by the transponder 2 or by its integrated circuit 27, this will result in the different station identification data block SIDB-F being detected by the station identification signal detection means 45. This will then cause the station identification signal comparison means 47 to detect that different station identification signals are present in the station identification signal detection means 45 and in the station identification signal storage means 46, namely the station identification data block SIDB-F in the station identification signal detection means 45 and the station identification data block SIDB in the station identification signal storage means 46. Based on the result of this comparison, the station identification signal comparison means 47 in this operating instance cancels the fixing of the transponder 2 in its quiescent state, which was brought about by the quiescent state information storage means 44, as a result of which the read command, that is to say the read data block LDB, detected by the inquiry signal detection means 41, is activated by the sequence control means 37, which in turn results in a read operation being performed in the transponder 2 or in the integrated circuit 27 of the transponder 2. In the course of this read operation user data stored in the storage means 39 are read out by the sequence control means 37 and fed to the response signal generating means 42 for the formation of a response signal, which is then transmitted to the further communication station. That is to say, in other words, that the fixing of the quiescent states in the transponder 2 has been cancelled by the detection of the different station identification data block SIDB-F and that a further read operation by means of the further communication station has therefore been enabled immediately after a read operation has been performed by the communication station 1 according to FIG. 1.

In a modification of the communication station 1 according to FIG. 1, the station identification signal generating means 7 are designed for the generation of two different station identification signals. The two different station identification signals are here formed by a first station identification data block SIDB1 and a second station identification data block SIDB2. The station identification signal generating means 7 have a control input, to which a control data block can be fed, the absence of this control data block on the control input causing the station identification signal generating means 7 to generate the first station identification data block SIDB1 and the presence of this control data block on the control input causing the station identification signal generating means 7 to generate the second station identification data block SIDB2. This simple modification of the communication station 1 means that following a read-out of user information from a memory of the transponder 2, the read-out having been initiated by transmitting a read data block LDB in combination with the first station identification data block SIDB 1, and subsequently setting the transponder 2 into its quiescent state, setting to the quiescent state having been achieved by transmitting just the quiescent state initiating signal QMDB or by transmitting the quiescent state initiating signals QMDB in combination with the first station identification data block SIDB1, the transponder 2 set to its quiescent state can again be read out by means of the described modification of the communication station 1, that is by transmitting a new read data block LDB in combination with the second station identification data block SIDB 2 to the transponder 2.

It should be noted that a station identification signal, that is to say a station identification data block, need not be fixedly preset in a communication station 1, but that such a station identification data block SIDB may also be valid merely within certain time limits and may, for example, be determined by a random number generated by a random number generator, which may be valid only for a certain fixed or variable period of time.

It should be further mentioned that a station identification data block SIDB may consist merely of a small number of bits. The number of bits may be selected, for example, according to how many different communication stations a transponder can successively enter into communication with.

For example, a transponder can successively enter into communication with multiple communication stations if the transponder takes the form of an admission card and is carried by a person, who wishes to pass through a number of secured doors in succession, a communication station being provided in the area of each secured door and a different station identification signal being generatable by each communication station. Further examples of a transponder successively entering the respective communication area of multiple communication stations are firstly baggage conveyor belts with multiple baggage branches, each item of baggage being provided with a transponder and the baggage branches being controlled by means of communication stations, and secondly production lines with multiple machining stations.

It should be further mentioned that in the above-mentioned design variants of a transponder 2 according to the invention, the station identification signal comparison means 47 are designed to control the fixing of a quiescent state fixed by the quiescent state information storage means 44 provided as operating state information storage means. This means, in other words, that in the above-mentioned design variants of a transponder 2 according to the invention an operating state fixed by operating state information storage means 44 takes the form of the quiescent state. It need not necessarily be such a quiescent state of a transponder 2, however; rather in the case of an operating state fixed by means of operating state information storage means 44, fixing of which can be controlled by station identification signal comparison means 47, it may also be a waiting state of a transponder 2 or a quiescent state of a transponder 2 valid only for certain operating modes.

It should be further mentioned, that in the case of above-mentioned design variants of a communication station 1 according to the invention and of a transponder 2 according to the invention, the inquiry signal generating means 5 and the station identification signal generating means 7 and the response signal generating means 42 and the response signal detection means 8 and the inquiry signal detection means 41 and the station identification signal detection means 45 and the station identification signal storage means 46 and the station identification signal comparison means 47 and the operating state information storage means 44 are all designed for processing, that is to say for the generation or the processing or the detection or the storage of data blocks, which form the corresponding signals. It should be noted that the signals being generated or processed or detected or stored need not necessarily be data blocks, but that other signals or signal forms are also possible, such as analog signals or signal forms, for example.

1. A communication station (1),
which is designed for contactless communication with at least one transponder (2) and
which has inquiry signal generating means (5) for the generation of at least one inquiry signal (IDB, LDB, SDB) for at least one transponder (2) and
which has response signal detection means (8) for the detection of at least one response signal (ADB) transmitted to the communication station (1) by a transponder (2) and
which has transmission means (17) for the delivery of the minimum of one inquiry signal (IDB, LDB, SDB) to the minimum of one transponder (2) and for the reception of the minimum of one response signal (ADB) transmitted to the communication station (1) by a transponder (2),
characterized in that additional station identification signal generating means (7) are provided, by means of which at least one station identification signal (SIDB; SIDB1, SIDB2) can be generated, which can be delivered to at least one transponder (2) by transmission means (17) and by means of which the identity of the communication station (1) can be communicated to least one transponder (2).

2. A communication station (1) as claimed in claim 1, characterized in that the station identification signal generating means (7) are designed for the generation of at least two different station identification signals (SIDB1, SIDB2).

3. A communication station (1) as claimed in claim 1, characterized in that the communication station (1) has control means (24), which control means (24) provide for a combined generation and delivery of a station identification signal (SIDB) and of an inquiry signal (IDB, LDB).

4. A communication station (1) as claimed in claim 1,
characterized in that quiescent state initiating signal generating means (6) are additionally provided for the generation of a quiescent state initiating signal (QMDB), by means of which at least one transponder (2) can be set to a quiescent state, and characterized in that control means (24) are provided, which control means (24) provide for a combined generation and delivery of a station identification signal (SIDB) and of the quiescent state initiating signals (QMDB).

5. A transponder (2),
which is designed for contactless communication with at least one communication station (1) and
which has inquiry signal detection means (41) for the detection of at least one inquiry signal (IDB, LDB) transmitted to the transponder (2) by a communication station (1) and
which has response signal generating means (42) for the generation of at least one response signal (ADB) to be transmitted to a communication station (1) and
which has transmission means (25) for the reception of the minimum of one inquiry signal (IDB, LDB) and for the delivery of the minimum of one response signal (ADB) to a communication station (1),
characterized in that station identification signal detection means (45) are additionally provided for the detection of a station identification signal (SIDB) transmitted to the transponder (2) by a communication station (1) and
characterized in that station identification signal storage means (46) are provided for the storage of a station identification signal (SIDB) transmitted to the transponder (2) by a communication station (1) and
characterized in that station identification signal comparison means (47) are provided, which interact with the station identification signal detection means (45) and with the station identification signal storage means (46) and by means of which a station identification signal (SIDB) stored in the station identification signal storage means (46) can be compared with a station identification signal (SIDB, SIDB-F) detected by the station identification signal detection means (45).

6. A transponder (2) as claimed in claim 5,
characterized in that the transponder (2) contains operating state information storage means (44) contains, by means of which operating state information (QMI) can be stored and by means 6fwhich the transponder(2) can be fixed in an operating state determined by the operating state information (QMI), and
characterized in that the station identification signal comparison means (47) are designed to control the fixing of an operating state fixed by means of the operating state storage means (44) according to the result of a comparison obtainable by means of station signal identification comparison means (47).

7. A transponder (2) as claimed in claim 6, characterized in that the operating state information storage means (44) are designed as quiescent state information storage means (44).

8. An integrated circuit (27) for a transponder (2), which is designed for contactless communication with at least one communication station (1),
which circuit (27) has inquiry signal detection means (41) for the detection of at least one inquiry signal (IDB, LDB) transmitted to the circuit (27) by a communication station (1) and
which circuit (27) has response signal generating means (42) for the generation of at least one response signal (ADB) to be transmitted to a communication station (1) and
which circuit (27) has a connection (28) for the reception of the minimum of one inquiry signal (IDB, LDB) and for the delivery of the minimum of one response signal (ADB) to a communication station (1),
characterized in that station identification signal detection means (45) are additionally provided for the detection of a station identification signal (SIDB) transmitted to the circuit (27) by a communication station (1) and
characterized in that station identification signal storage means (46) are provided for the storage of a station identification signal (SIDB) transmitted to the circuit (27) by a communication station (1) and
characterized in that station identification signal comparison means (47) are provided, which interact with the station identification signal detection means (45) and with the station identification signal storage means (46) and by means of which a station identification signal (SIDB) stored in the station identification signal storage means (46) can be compared with a station identification signal (SIDB, SIDB-F) detected by the station identification signal detection means (45).

9. A circuit (27) as claimed in claim 8,
characterized in that the circuit (27) contains operating state information storage means (44), by means of which operating state information (QMI) can be stored and by means of which the circuit (27) can be fixed in an operating state determined by the operating state information (QMI), and
characterized in that the station identification signal comparison means (47) are designed for control of the fixing of an operating state fixed by operating state information storage means (44) according to the result of a comparison obtainable by means of station signal identification signal comparison means (47).

10. A circuit (27) as claimed in claim 9, characterized in that the operating state information storage means (44) are designed as quiescent state information storage means (44).
